(19) United States
(12) Patent Application Publication
(10) Pub. No.: US 2025/0206347 A1
(43) Pub. Date: Jun. 26, 2025

(54) IN-VEHICLE ARTIFICIAL INTELLIGENCE ASSISTANT FOR CALAMITY ACCIDENT PREVENTION AND RELATED METHOD

(71) Applicant: Toyota Jidosha Kabushiki Kaisha, Toyota-shi Aichi-ken (JP)

(72) Inventors: Divya Garikapati, San Jose, CA (US); Hiroshi Yasuda, San Carlos, CA (US)

(21) Appl. No.: 18/390,255

(22) Filed: Dec. 20, 2023

(51) Int. Cl. B60W 60/00; B60W 40/02; B60W 50/14

(52) U.S. Cl. CPC B60W 60/0016; B60W 40/02; B60W 50/14; B60W 2540/22; B60W 2555/20

(57) ABSTRACT

Described are systems and methods for calamity accident prevention using an artificial intelligence system. In one example, a system that utilizes an in-vehicle artificial intelligence system includes a processor and a memory in communication with the processor. The memory includes instructions that, when executed by the processor, cause the processor to receive an input from an occupant of a vehicle describing a calamity when the vehicle is traveling on an initial route and determine a mood of the occupant when the occupant provided the input. Based on a probability of the calamity occurring in a location of the vehicle and the mood of the occupant, the instructions cause the processor to perform route planning for the vehicle to minimize the effects of the calamity on the vehicle.

### TECHNICAL FIELD

The subject matter described herein relates, in general, to systems and methods for calamity accident prevention.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Some current vehicles can calculate a route from an origin to a destination. Moreover, the operator of the vehicle provides the destination, and the origin is usually provided through a vehicle location system. After receiving the origin and destination, a routing computer can determine the appropriate route for a vehicle to utilize when traveling from the origin to the destination. The route may be calculated utilizing a number of different algorithms that generally seek to minimize travel time, distance, or other variables. Once the route is calculated, the route may be displayed to the operator of the vehicle using visual/audible directions or may be provided to an autonomous driving system that causes the vehicle to pilot itself autonomously along the calculated route.

### SUMMARY

This section generally summarizes the disclosure and is not a comprehensive explanation of its full scope or all its features.

In one embodiment, a system that utilizes an in-vehicle artificial intelligence (AI) system includes a processor and a memory in communication with the processor. The memory includes instructions that, when executed by the processor, cause the processor to receive an input from an occupant of a vehicle describing a calamity when the vehicle is traveling on an initial route and determine a mood of the occupant when the occupant provided the input. Based on a probability of the calamity occurring in a location of the vehicle and the mood of the occupant, the instructions cause the processor to perform route planning for the vehicle to minimize the effects of the calamity on the vehicle. The route planning can take a number of different forms and can include rerouting the vehicle to utilize another route that avoids the effects of the calamity, rerouting the vehicle to a safe location and/or the home of the occupant of the vehicle, etc.

In another embodiment, a method that utilizes an in-vehicle AI system can include the steps of receiving an input from an occupant of a vehicle describing a calamity when the vehicle is traveling on an initial route and determining a mood of the occupant when the occupant provided the input. Based on a probability of the calamity occurring in a location of the vehicle and the mood of the occupant, the method performs route planning for the vehicle to minimize the effects of the calamity on the vehicle. Like before, the route planning can take a number of different forms and can include rerouting the vehicle to utilize another route that avoids the effects of the calamity, rerouting the vehicle to a safe location and/or the home of the occupant of the vehicle, etc.

In yet another embodiment, a non-transitive computer-readable medium includes instructions that, when executed by a processor, cause the processor to receive an input from an occupant of a vehicle describing a calamity when the vehicle is traveling on an initial route and determine a mood of the occupant when the occupant provided the input. Based on a probability of the calamity occurring in a location of the vehicle and the mood of the occupant, the instructions cause the processor to perform route planning for the vehicle to minimize the effects of the calamity on the vehicle. Again, the route planning can take a number of different forms and can include rerouting the vehicle to utilize another route that avoids the effects of the calamity, rerouting the vehicle to a safe location and/or the home of the occupant of the vehicle, etc.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a scenario wherein an in-vehicle AI assistant system reroutes a vehicle to avoid a calamity.

FIG. 2 illustrates one example of a vehicle incorporating the in-vehicle AI assistant system.

FIG. 3 illustrates a more detailed view of the in-vehicle AI assistant system.

FIGS. 4A-4F illustrate different types of facial expressions that the in-vehicle AI assistant system can utilize to determine the mood of the occupant of the vehicle.

FIGS. 5A and 5B illustrate one example of a method that an in-vehicle AI system may utilize for rerouting a vehicle to avoid a calamity.

### DETAILED DESCRIPTION

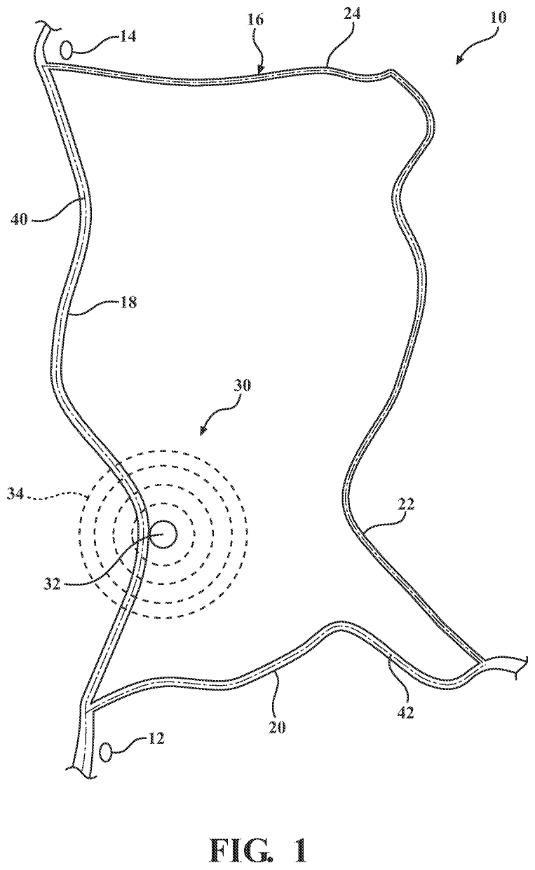

Described are in-vehicle AI assistant systems and related methods that can appropriately route a vehicle to avoid a calamity. In order to better understand this concept, reference is made to FIG. 1, which illustrates a scenario 10, wherein a vehicle wishes to travel from an origin 12 to a destination 14. Also illustrated is a road network 16, including a collection of roads 18, 20, 22, and 24. Normally, a routing computer of a vehicle would route the vehicle from the origin 12 to the destination 14 using the route 40, which generally proceeds along the road 18. As it is generally well known, routing computers utilize algorithms that generally seek to minimize the time, distance, fuel requirements, etc., when calculating a particular route from an origin to a destination.

In this scenario 10, a calamity 30 is shown. In this example, the calamity 30 is in the form of an earthquake having an epicenter 32 and an affected area 34 around the epicenter 32. It should be understood that the in-vehicle AI assistant system and related methods can relate to any one of a number of different calamities and should not be limited to earthquakes. Other types of example calamities could include floods, forest fires, insurrections or other civil disturbances, hurricanes, tsunamis, extreme weather, etc. As will be explained in greater detail later in this description, the in-vehicle AI assistant system can collect information and calculate the probability that one or more particular calamities, such as the calamity 30 may occur and provide and/or select an appropriate alternative route, such as route 42 which utilizes roads 20, 22, and 24 and effectively avoids the calamity 30 and the affected area 34. As such, the route 42 may actually be longer than the route 40, but it has the advantage that it is less likely to be affected by a calamity, such as the calamity 30.

In addition, as will be described in greater detail later, the in-vehicle AI assistant system can also actively monitor inputs provided by the operator, such as voice utterances for descriptions of natural calamities. When such an utterance is received, the in-vehicle AI assistant system determines the mood of the occupant when making the utterance and the probability that the calamity could actually occur. Depending on the mood and the probability, the in-vehicle AI assistant system may perform route planning to avoid or minimize the effects of the calamity on the vehicle and/or the occupant of the vehicle. If the mood and/or probability does not indicate that a calamity is occurring, the in-vehicle AI assistant system can request that the occupant confirm that a calamity is actually occurring. By considering both mood and probability of the calamity occurring, the in-vehicle AI assistant system can filter false positives appropriately, thereby giving the occupants of the vehicle more confidence in the capabilities of the in-vehicle AI system.

Referring to FIG. 1, an example of a vehicle 100 is illustrated that may incorporate an in-vehicle AI assistant system 200. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein.

In various embodiments, the automated/autonomous systems or combination of systems may vary. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control, as discussed in relation to an autonomous driving system 170.

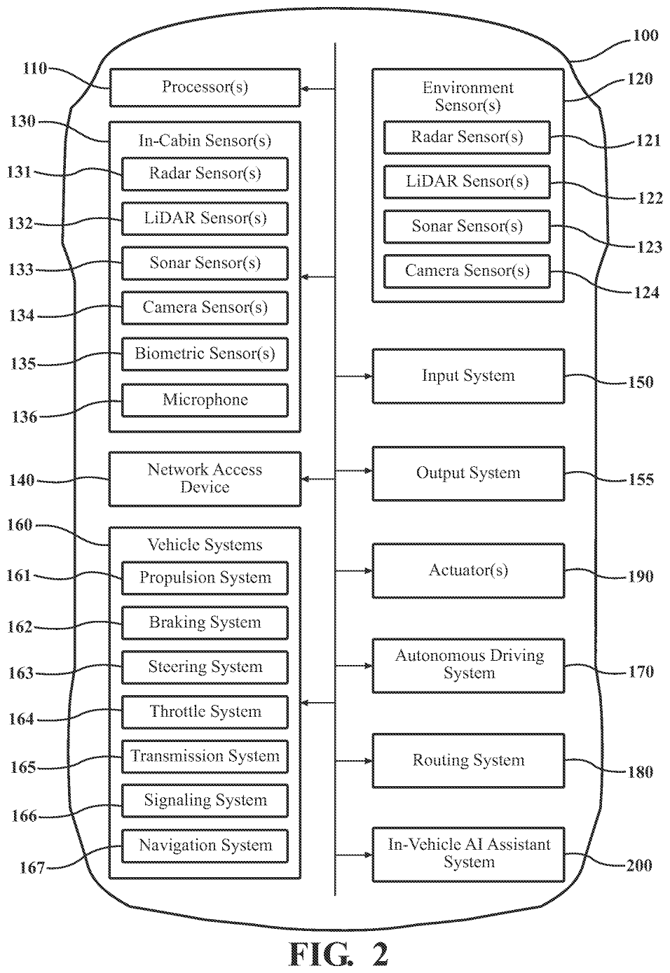

The vehicle 100 also includes various elements. It will be understood that in various embodiments it may not be necessary for the vehicle 100 to have all of the elements shown in FIG. 2. The vehicle 100 can have any combination of the various elements shown in FIG. 2. Further, the vehicle 100 can have additional elements to those shown in FIG. 2. In some arrangements, the vehicle 100 may be implemented without one or more of the elements shown in FIG. 2. While the various elements are shown as being located within the vehicle 100 in FIG. 2, it will be understood that one or more of these elements can be located external to the vehicle 100. Further, the elements shown may be physically separated by large distances and provided as remote services (e.g., cloud-computing services).

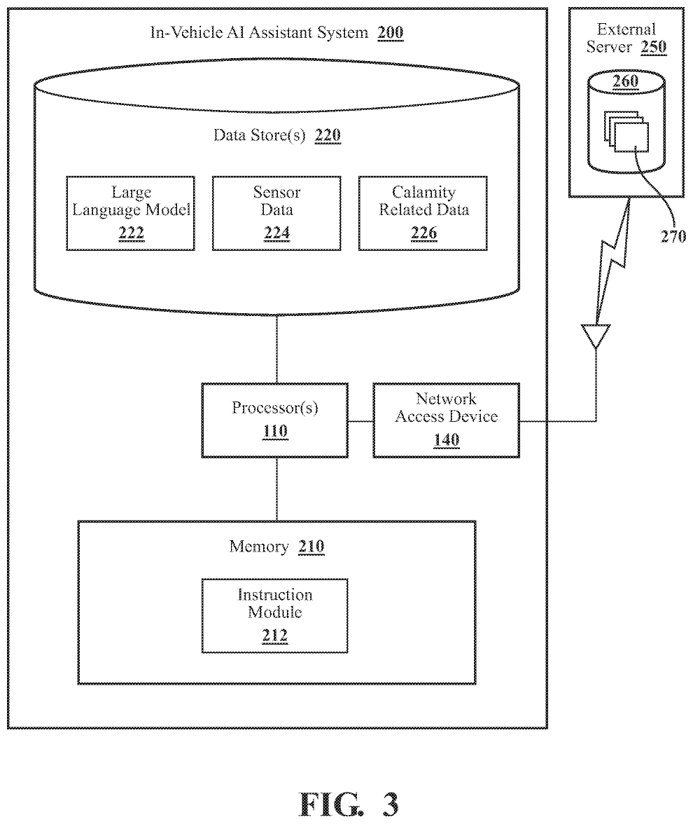

Some of the possible elements of the vehicle 100 are shown in FIG. 2 and will be described along with subsequent figures. However, a description of many of the elements in FIG. 2 will be provided after the discussion of FIGS. 3-5B for the purpose of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 includes the in-vehicle AI assistant system 200. The in-vehicle AI assistant system 200 may be incorporated within the autonomous driving system 170 (if the vehicle 100 is so equipped) and/or a routing system 180 that can determine routes for the vehicle 100 to utilize. With reference to FIG. 3, one embodiment of the in-vehicle AI assistant system 200 is further illustrated. As shown, the in-vehicle AI assistant system 200 includes a processor(s) 110. Accordingly, the processor(s) 110 may be a part of the in-vehicle AI assistant system 200 or the in-vehicle AI assistant system 200 may access the processor(s) 110 through a data bus or another communication path. In one or more embodiments, the processor(s) 110 is an application-specific integrated circuit that is configured to implement functions associated with an instruction module 212 that includes instructions for executing any of the methods described in this disclosure. In general, the processor(s) 110 is an electronic processor, such as a microprocessor, that is capable of performing various functions as described herein.

In one embodiment, the in-vehicle AI assistant system 200 includes a memory 210 that stores the instruction module 212. The memory 210 may be a random-access memory (RAM), read-only memory (ROM), a hard disk drive, a flash memory, or other suitable memory for storing the instruction module 212. As mentioned before, the instruction module 212 is, for example, computer-readable instructions that, when executed by the processor(s) 110, cause the processor(s) 110 to perform the various functions disclosed herein.

Furthermore, in one embodiment, the in-vehicle AI assistant system 200 includes a data store(s) 220. The data store(s) 220 is, in one embodiment, an electronic data structure such as a database that is stored in the memory 210 or another memory and that is configured with routines that can be executed by the processor(s) 110 for analyzing stored data, providing stored data, organizing stored data, and so on. Thus, in one embodiment, the data store(s) 220 stores data used by instructions stored in the instruction module 212 in executing various functions.

In this example, the data store(s) 220 includes a large language model 222, sensor data 224, and calamity-related data 226. As to the large language model 222, the large language model 222 allows the in-vehicle AI assistant system 200 to achieve general-purpose language understanding and generation with one or more occupants of the vehicle 100. For example, the large language model 222 may have been able to acquire these abilities by using massive amounts of data to learn numerous parameters during training.

The sensor data 224 can be any sensor data collected by one or more systems and subsystems of the vehicle 100. For example, the sensor data 224 can include data collected within the cabin, such as data related to one or more occupants of the vehicle 100 using the in-cabin sensors 130 shown in FIG. 2. Additionally, the sensor data 224 can also include sensor data regarding the environment in which the vehicle 100 operates within and may be collected by one or more environment sensor(s) 120, also shown in FIG. 2. Details regarding how the sensor data 224 is utilized by the in-vehicle AI assistant system 200 will be provided later in this description.

As to calamity-related data 226, the calamity-related data relates to the actual occurrence and/or probable occurrence of a calamity at one or more locations, such as locations the vehicle 100 is operating. In order to keep the calamity-related data 226 up-to-date, the processor(s) 110 may utilize a network access device 140 that allows the in-vehicle AI assistant system 200 to communicate with external devices, such as an external server 250. The external server 250 may include database 260, which includes data 270 that describes the actual or probable occurrences of calamities at a particular location. As mentioned before, the type of calamity information stored within the calamity-related data 226 can include any type of calamity, such as earthquakes, floods, forest fires, civil insurrections, tsunamis, hurricanes, tornadoes, severe weather, and so on.

Turning attention to the instruction module 212, as mentioned before, the instruction module 212 includes instructions that, when executed by the processor(s) 110, cause the processor(s) 110 to perform any of the functions described herein. In one example, the instructions of the instruction module 212 cause the processor(s) 110 to obtain calamity information that may be stored within the calamity-related data 226. As mentioned before, this will be achieved by having the processor(s) 110 request updated data 270 from an external server 250 via a network access device 140. This essentially allows the in-vehicle AI assistant system 200 to have updated calamity-related information regarding any actual calamity occurring or any probability of any calamities occurring near the location of the vehicle 100 or near any routes that the vehicle 100 may utilize.

The instruction module 212 also allows the processor(s) 110 of the in-vehicle AI assistant system 200 to generate a route from an origin to a destination. For example, as mentioned when describing FIG. 1, an occupant of the vehicle may provide the destination 14 to a routing system 180. The origin 12 may be provided by the occupant to the routing system 180 or may be provided to the routing system 180 by one or more vehicle systems and subsystems, such as the navigation system 167, shown in FIG. 2. In some cases, the navigation system 167 may utilize one or more global navigation satellite systems, such as Global Positioning System (GPS), Global Navigation Satellite System (GLONASS), BeiDou Navigation Satellite System, and Galileo to determine the origin of the vehicle 100.

Once receiving the origin and the destination, the routing system 180 can utilize any one of a number of different algorithms for calculating one or more routes between the origin and the destination. Generally, the routing system 180 may utilize algorithms that may minimize and/or maximize certain attributes. For example, the routing system 180 may generate routes that are shortest in length or time or require the least amount of fuel/charge. In other cases, routing system 180 may generate routes that avoid certain types of roads, such as expressways, or avoid turns or other maneuvers that the occupant may wish to avoid.

Once the routes are generated by the routing system 180, the instruction module 212 may cause the processor(s) 110 to display the routes to the occupant of the vehicle utilizing an output system 155, which could be a display system. If multiple routes are provided to the occupant, the instruction module 212 may cause the processor(s) 110 to receive an input from the occupant, such as via the input system 150, that selects one of the calculated routes.

In addition to providing the route to the occupants via the output system 155, the instruction module 212 may also cause the processor(s) 110 to provide calamity-related information along with the route information. The calamity-related information can include if one of the calculated routes is experiencing a calamity and/or the probability that the one or more routes may experience a calamity. This information, as mentioned previously, may be stored within the calamity-related data 226 and may be updated by communicating with the external server 250. By so doing, this allows the occupant to weigh the benefits/risks with any particular route and allows the occupant to select whichever route they believe balances the benefits/risks best for them.

In some cases, the instruction module 212 may cause the processor(s) 110 to provide only a single route to the occupant by the output system 155 but also provide calamity probability information. If the probability is above a certain threshold, such as greater than 10% or some other threshold, the instruction module 212 may cause the processor(s) 110 to display via the output system 155 some warning regarding the potential for the calamity and possibly receive some confirmation from the occupant that the occupant still wishes to utilize the route.

Once the route has been finalized and selected by the occupant, the instruction module 212 may cause the processor(s) 110 to execute the route plan. The execution of the route plan may include displaying route-related prompts (turn right in 100 feet, stay in the left lane, etc.) to the occupant by the output system 155 so that the occupant can properly drive the vehicle 100 to execute the route. If the vehicle 100 is autonomous or has some form of autonomous capability, the route may be provided to an autonomous driving system 170, which can then pilot the vehicle autonomously on some or all of the selected route.

When traveling along the route, the instruction module 212 also causes the processor(s) 110 to monitor for any type of utterance input provided by the occupant via a sensor, such as a microphone 136. Essentially, the processor(s) 110 examines audio data provided by the microphone 136 for utterances that describe a calamity or provide emergency instructions. Examples of these utterances can include phrases such as “Earthquake!”, “Forest Fire!”, “Flooding!”, “Reroute!”, “Danger!”, etc. It is important to understand that these example utterances are just a small sample of the utterances that the processor(s) 110 examines to determine if they relate to calamity and/or emergency instructions.

Upon determining that the utterance input describes a calamity or emergency instructions, the instruction module 212 causes the processor(s) 110 to determine the mood of the occupant providing the utterance input and the probability of a calamity occurring in the location of the vehicle 100 when the occupant provided the utterance input. As to the probability of the calamity occurring, the processor(s) 110 has access to calamity-related data 226 that may contain probabilities of a calamity occurring or may provide some base data that can be utilized by the processor(s) 110 to determine the probability that one or more calamities may occur in the location of the vehicle at the time that the occupant provided the utterance input.

As to determining the mood of the occupant, the instruction module 212 may include instructions that, when executed by the processor(s) 110, cause the processor(s) 110 to receive information from the in-cabin sensors 130. The in-cabin sensors 130 can include a number of different sensors, including radar sensor(s) 131, LIDAR sensor(s) 132, sonar sensor(s) 133, camera sensor(s) 134, biometric sensor(s) 135, etc. In particular, images captured by the camera sensor(s) 134 of the occupant may provide information regarding the body language and/or facial expressions of the occupant that can be utilized to determine the overall mood of the occupant when providing the utterance input.

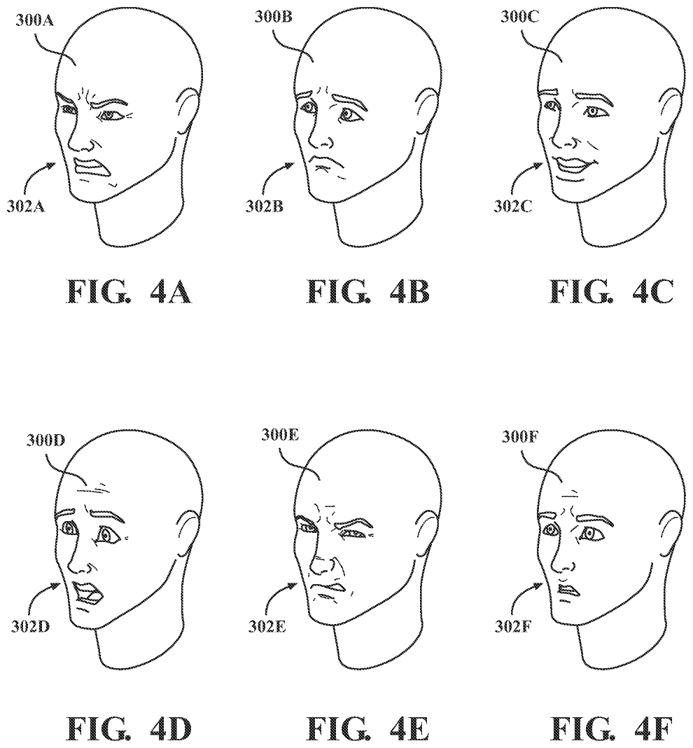

For example, FIGS. 4A-4E illustrate faces 300A-300E of different types of facial expressions 302A-302E of the occupant that generally align with the mood of the occupant. In particular, by monitoring the mouth shape, forehead, eyes, and other facial features of the occupant, one or more moods can be derived. For example, the facial expression 302A generally relates to anger, the facial expression 302B relates to sadness, the facial expression 302C relates to happiness and/or sociability, the facial expression 302D relates to fear, the facial expression 302E relates to disgust, and the facial expression 302F relates to surprise.

The mood of the occupant based on the facial expressions or other information may play a role in determining the overall confidence that the occupant is actually describing a calamity that is occurring. For example, if the mood of the occupant is happy or sociable, such as shown in the facial expression 302C, the utterance input provided by the occupant indicating that a calamity has occurred or is in the process of occurring, may not be describing a factual event. For example, the occupant could be conversing with someone else about an unrelated event or could be merely talking about calamities in a purely metaphorical sense.

However, other types of moods, such as anger (facial expression 302A), sadness (facial expression 302B), fear (facial expression 302D), disgust (facial expression 302E), and/or surprise (facial expression 302F), may indicate that the calamity provided in the utterance input by the occupant is actually occurring are being experienced by the occupant.

It should also be understood that while the moods described above are based on facial expressions, it is also possible that the mood of the occupant can be determined utilizing other information, such as biometric information that may be collected from biometric sensor(s) 135 and/or body language information that can be captured from for many of the in-cabin sensors 130. For example, the body language of the occupant may be utilized to either augment and/or confirm moods determined by facial expressions. Further still, the body language of the occupant may be used solely to determine the mood of the occupant, instead of relying on facial expressions.

The instruction module 212 includes instructions that, when executed by the processor(s) 110, consider both the probability that a calamity is occurring and the mood of the occupant to determine what action should be taken next. If it is determined that the mood of the occupant indicates anger, sadness, fear, and/or disgust, and/or surprise and a probability that the calamity may actually occur (such as greater than 10% or some other threshold value), the processor(s) 110 may then perform route planning to avoid or minimize the impact of the calamity on the occupant and/or the vehicle 100.

Conversely, the instruction module 212 can also cause the processor(s) 110 to request confirmation from the occupant that the calamity has occurred. For example, if the mood of the occupant is happy and/or the probability that the calamity will occur is low (such as less than 10%), the processor(s) 110 may request confirmation from the occupant via the output system 155 in the input system 150. For example, the output system 155 could visually or audibly ask the occupant if a particular calamity is occurring.

If the calamity is either confirmed by the occupant or was determined as being likely to be occurring based on the mood and probability previously described, the instruction module 212 causes the processor(s) 110 to perform appropriate route planning to avoid or minimize the impact of the calamity on the vehicle 100 and/or the occupant. The processor(s) 110 may take any one of a number of different actions to minimize the effect of the calamity on the vehicle 100 and/or the occupant. These actions can include rerouting the vehicle 100 to avoid the epicenter/affected area of the calamity, rerouting the vehicle 100 to utilize routes with a lesser probability of being impacted by the calamity, rerouting the vehicle 100 to the origin and/or a home location, and/or providing information regarding the location of a shelter or another safe location.

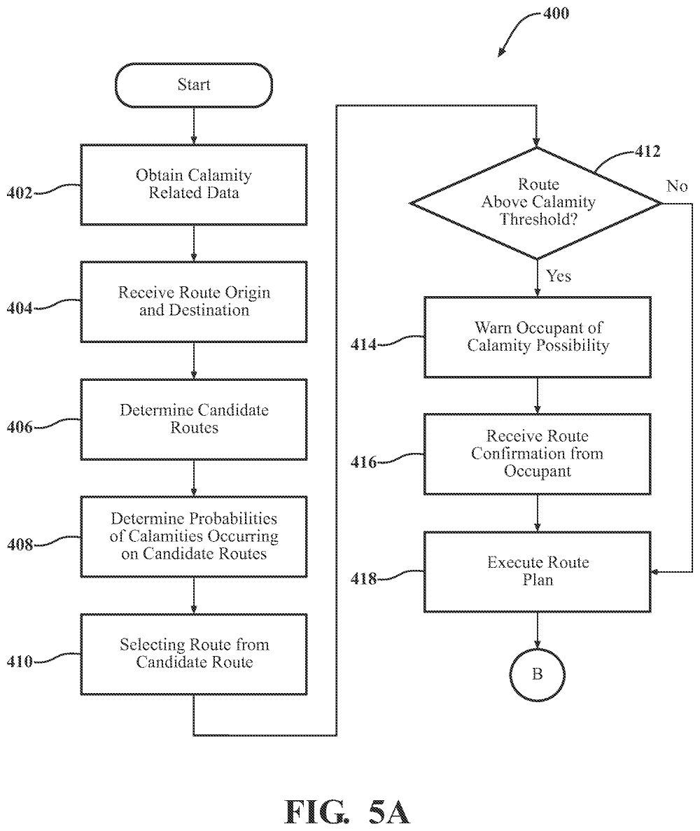

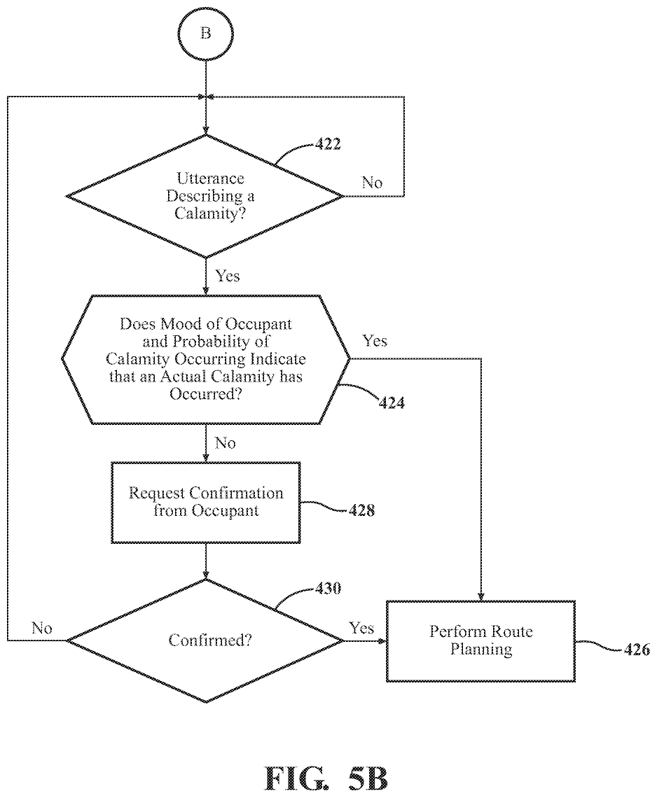

Referring to FIGS. 5A and 5B, a method 400 for minimizing the effects of the calamity on the vehicle and/or an occupant of the vehicle is shown. The method 400 will be described from the viewpoint of the vehicle 100 of FIG. 2 and the in-vehicle AI assistant system 200 of FIG. 3. However, it should be understood that this is just one example of implementing the method 400. While method 400 is discussed in combination with the in-vehicle AI assistant system 200, it should be appreciated that the method 400 is not limited to being implemented within the in-vehicle AI assistant system 200, but is instead one example of a system that may implement the method 400. It should be noted that some of the steps of the method 400 may have previously been described when describing the functionality provided by the instructions of the instruction module 212. As such, any methodologies or features described above should be understood to also be possibly incorporated within the method 400.

In step 402, the instructions of the instruction module 212 cause the processor(s) 110 to obtain calamity-related data. The calamity-related data can be the calamity-related data 226 stored within the data store(s) 220. As explained previously, the calamity-related data 226 may be updated by interfacing with an external server 250 that can collect and disseminate updates regarding calamities at a particular location.

In step 404, the routing system 180 of the vehicle 100 may receive origin and destination information. The origin information may be provided by the navigation system 167 of the vehicle 100, while the occupant of the vehicle may provide the destination formation by interfacing with the input system 150. The instruction module 212 may then cause the processor(s) 110 to determine one or more candidate routes using the origin and destination, as shown in step 406. This may be achieved by utilizing one or more algorithms by the routing system 180 that minimize or maximize one or more route attributes, such as length, time, fuel economy, etc.

Once the candidate routes are determined, in step 408, the instruction module 212 may cause the processor(s) 110 to determine probabilities of calamities occurring on the candidate routes, as indicated in step 408. For example, the processor(s) 110 may use the calamity-related data 226 to determine if any of the candidate routes are being impacted by an actual calamity and/or the probability of one or more natural calamities occurring when utilizing one of the candidate routes. The candidate routes, as well as the probabilities of one or more calamities occurring on any of the candidate routes, may be provided to the occupant via the output system 155.

In step 410, the instruction module 212 may cause the processor(s) 110 to receive a selection from the occupant via the input system 150. For example, if multiple candidate routes are provided to the occupant along with calamity probability information, the occupant can select whichever route they believe balances the risk/benefits best for that particular occupant. In some cases, if the occupant greatly values time, the occupant may choose a shorter route that has a greater risk. Conversely, if the occupant is very risk-averse, the occupant may be willing to select a route that is longer but has a lower risk of being impacted by a calamity.

In some cases, as illustrated in step 412, the instruction module 212 may cause the processor(s) 110 to determine if the selected route is above a calamity threshold, indicating that the route is either impacted by a calamity or has a very high likelihood of being impacted by a calamity. In particular, if a route is actually impacted by a calamity or has a very high risk of being impacted by a calamity, the processor(s) 110 may utilize the output system 155 to provide a warning to the occupant, as shown in step 414.

In step 416, the instruction module 212 may cause the processor(s) 110 to receive route confirmation from the occupant. In some cases, especially in situations where there is a likelihood of a calamity impacting the route, the in-vehicle AI assistant system 200 may request that the occupant confirm the route they wish to use. In step 418, once the route has been confirmed, instruction module 212 cause the processor(s) 110 to execute the route plan. As previously described, this may be simply displaying route instructions to the occupant via the output system 155 so that the occupant can drive the vehicle 100 accordingly, or it could be a set of instructions provided to the autonomous driving system 170, causing the autonomous driving system 170 to issue commands that control the operation of the vehicle 100 such that the vehicle 100 can autonomously travel along the selected route.

In step 422, the instruction module 212 causes the processor(s) 110 to continuously monitor for utterances provided by the occupants of the vehicle 100. In particular, the processor(s) 110 continuously monitors for utterances describing a calamity, such as an earthquake, hurricane, civil insurrection, tsunami, forest fire, severe weather, etc. This can be achieved by monitoring the signals of the microphone 136 for any utterances provided by the occupants of the vehicle 100.

If there is an utterance describing a calamity or some other emergency, the method proceeds to step 424, wherein the instruction module 212 causes the processor(s) 110 to consider both the mood of the occupant and the probability of the calamity occurring in order to determine if the calamity described in the utterance by the occupant is actually occurring. By considering both the mood of the occupant and the probability of the described calamity actually occurring in the location of the vehicle, the in-vehicle AI assistant system 200 can filter for false positives/false negatives so as not to unnecessarily interrupt or take inappropriate actions that the occupant did not wish for the in-vehicle AI assistant system 200 to execute.

If it is determined that both the mood and probability indicate that the calamity described in the utterance input by the occupant is actually occurring, the method 400 proceeds to step 426, where the instruction module 212 causes the processor(s) 110 to perform appropriate route planning. As described earlier, this route planning can include rerouting the vehicle to utilize another route that avoids the effects of the calamity, rerouting the vehicle to a safe location and/or the home of the occupant of the vehicle, etc.

If it is determined that the mood and/or the probability cast some doubt that the calamity is actually occurring, the method may proceed to step 430, wherein the instruction module 212 causes the processor(s) 110 to assess the occupant for confirmation that the calamity is occurring. Moreover, the processor(s) 110 may communicate with the occupant by asking for confirmation by utilizing the output system 155. It may receive confirmation by utilizing the input system 150 and/or the microphone 136. If confirmation is received, the method 400 proceeds to step 426. Otherwise, the method may return to step 422 and continually monitor for utterances describing calamities by the occupants of the vehicle 100.

Once step 426 has occurred, the method 400 can either end or return to any of the previously described steps, such as step 422, wherein the method will continue to monitor for utterances from the occupants describing calamities.

The in-vehicle AI assistant system 200 and the methods described herein help minimize the impacts of calamities on the vehicle 100 and/or the occupants of the vehicle 100 by considering the probability that a particular calamity may occur on a route. Additionally, the in-vehicle AI assistant system 200 and associated method continuously monitors for utterances by the occupants describing a calamity and then considers the mood and/or the probability that the calamity is actually occurring before any additional actions are taken. As such, by considering the mood and/or the probability that the calamity is actually occurring, the in-vehicle AI assistant system 200 and the associated methods can filter out any false positives/false negatives to improve the overall functionality of the system and improve the occupant's confidence in the system.

FIG. 2 will now be discussed in full detail as an example environment within which the system and methods disclosed herein may operate. In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route.

As mentioned, the vehicle 100 can include one or more processor(s) 110. In one or more arrangements, the processor(s) 110 can be a main processor of the vehicle 100. For instance, the processor(s) 110 can be an electronic control unit (ECU). As noted above, the vehicle 100 can include environment sensor(s) 120 for sensing the environment surrounding the vehicle 100 and in-cabin sensors for monitoring the occupants and the interior of the vehicle 100. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made or that enables the processor to keep up with some external process.

The environment sensor(s) 120 can include any suitable type of sensor configured to acquire, and/or sense driving environment data. “Driving environment data” includes data or information about the external environment in which an autonomous vehicle is located or one or more portions thereof. For example, the one or more environment sensor(s) 120 can be configured to detect, quantify and/or sense obstacles in at least a portion of the external environment of the vehicle 100 and/or information/data about such obstacles. Such obstacles may be stationary objects and/or dynamic objects. The one or more environment sensor(s) 120 can be configured to detect, measure, quantify, and/or sense other things in the external environment of the vehicle 100, for example, lane markers, signs, traffic lights, traffic signs, lane lines, crosswalks, curbs proximate the vehicle 100, off-road objects, etc.

Various examples of sensors of the environment sensor(s) 120 will be described herein. It will be understood that the embodiments are not limited to the particular sensors described. As an example, in one or more arrangements, the environment sensor(s) 120 can include one or more radar sensors 121, one or more LIDAR sensors 122, one or more sonar sensors 123, and/or one or more cameras 124.

Similarly, the in-cabin sensors 130 can also include one or more radar sensor(s) 131, one or more LIDAR sensor(s) 132, one or more sonar sensor(s) 133, and/or one or more camera sensor(s) 134. In addition, the in-cabin sensors 130 can also include biometric sensor(s) 135 for measuring or more physiological conditions of the occupants of the vehicle 100 and a microphone 136 for monitoring utterances by the occupants of the vehicle 100. In particular, the in-cabin sensors 130 can be utilized to determine the mood of the occupants by analyzing facial expressions, body language, and/or biometric information of the occupants.

The vehicle 100 can include an input system 150. An “input system” includes any device, component, system, element, arrangement, or groups thereof that enable information/data to be entered into a machine. The input system 150 can receive an input from a vehicle passenger (e.g., a driver or a passenger). The vehicle 100 can include an output system 155. An “output system” includes any device, component, arrangement, or groups thereof that enable information/data to be presented to a vehicle passenger (e.g., a person, a vehicle passenger, etc.).

The vehicle 100 can include one or more vehicle systems 160. Various examples of the one or more vehicle systems 160 are shown in FIG. 2. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 161, a braking system 162, a steering system 163, a throttle system 164, a transmission system 165, a signaling system 166, and/or a navigation system 167. Each of these systems can include one or more devices, components, and/or a combination thereof, now known or later developed.

The navigation system 167 can include one or more devices, applications, and/or combinations thereof, now known or later developed, configured to determine the geographic location of the vehicle 100 and/or to determine a travel route for the vehicle 100. The navigation system 167 can include one or more mapping applications to determine a travel route for the vehicle 100. The navigation system 167 can include a global positioning system, a local positioning system, or a geolocation system.

The autonomous driving system 170 can be operatively connected to communicate with the vehicle systems 160 and/or individual components thereof. For example, the processor(s) 110 and/or the autonomous driving system 170 can be in communication to send and/or receive information from the vehicle systems 160 to control the movement, speed, maneuvering, heading, direction, etc. of the vehicle 100. The processor(s) 110 and/or the autonomous driving system 170 may control some or all of these vehicle systems 160 and, thus, may be partially or fully autonomous.

The processor(s) 110 and/or the autonomous driving system 170 can be operatively connected to communicate with the vehicle systems 160 and/or individual components thereof. For example, returning to FIG. 2, the processor(s) 110 and/or the autonomous driving system 170 can be in communication to send and/or receive information from the vehicle systems 160 to control the movement, speed, maneuvering, heading, direction, etc. of the vehicle 100. The processor(s) 110 and/or the autonomous driving system 170 may control some or all of these vehicle systems 160.

The processor(s) 110 and/or the autonomous driving system 170 may be operable to control the navigation and/or maneuvering of the vehicle 100 by controlling one or more of the vehicle systems 160 and/or components thereof. For instance, when operating in an autonomous mode, the processor(s) 110 and/or the autonomous driving system 170 can control the direction and/or speed of the vehicle 100. The processor(s) 110 and/or the autonomous driving system 170 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either directly or indirectly.

The vehicle 100 can include one or more actuators 190. The actuators 190 can be any element or combination of elements operable to modify, adjust, and/or alter one or more of the vehicle systems 160 or components thereof to responsive to receiving signals or other inputs from the processor(s) 110 and/or the autonomous driving system 170. Any suitable actuator can be used. For instance, the one or more actuators 190 can include motors, pneumatic actuators, hydraulic pistons, relays, solenoids, drive-by-wire actuators, and/or piezoelectric actuators, to name a few possibilities.

The vehicle 100 can include one or more modules, at least some of which are described herein. The modules can be implemented as computer-readable program code that, when executed by a processor(s) 110, implements one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements can also be embedded in an application product that comprises all the features enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. Other suitable components could include additional central processing units (CPUs) and/or graphics processing units (GPUs). In particular, GPUs may be required for AI Assistant development, implementation, training, and testing.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, partly on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). For example, vehicle-to-everything (V2X) can be used to communicate to other devices to share computational, storage communication, etc., resources. Vehicular ad hoc networks (VANETs) can also be utilized, which are created by applying the principles of mobile ad hoc networks—the spontaneous creation of a wireless network of mobile devices—to the domain of vehicles.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor, the memory having instructions that, when executed by the processor, cause the processor to:
receive an input from an occupant of a vehicle describing a calamity when the vehicle is traveling on an initial route;
determine a mood of the occupant when the occupant provided the input; and
based on a probability of the calamity occurring in a location of the vehicle and the mood of the occupant, perform route planning for the vehicle for minimizing effects of the calamity on the vehicle.

2. The system of claim 1, wherein the input is an utterance from the occupant.

3. The system of claim 1, wherein the calamity is at least one of: an earthquake, forest fire, flood, tornado, hurricane, and tsunami.

4. The system of claim 1, wherein the memory further comprises instructions that, when executed by the processor, cause the processor to provide the probability to the occupant of the calamity occurring on the initial route before the vehicle proceeds along the initial route.

5. The system of claim 1, wherein the route plaining includes at least one of:
rerouting the vehicle to avoid an epicenter of the calamity;
rerouting the vehicle to utilize routes with a lesser probability of the calamity impacting the vehicle;
rerouting the vehicle to a home location;
providing options to the occupant to select a different route; and
providing information regarding the location of a shelter or another safe location.

6. The system of claim 1, wherein the memory further comprises instructions that, when executed by the processor, cause the processor to:
receive occupant data from an in-cabin sensor; and
based on the occupant data, determine the mood of the occupant, wherein the mood of the occupant includes at least one or more of: anger, sadness, fear, disgust, surprise, happy, and sociable.

7. The system of claim 6, wherein the memory further comprises instructions that, when executed by the processor, cause the processor to:
when the mood of the occupant is at least one of happy and sociable, request additional information from the occupant regarding the calamity, wherein the additional information includes at least one of confirmation that the calamity is occurring and the location of the calamity.

8. The system of claim 1, wherein the memory further comprises instructions that, when executed by the processor, cause the processor to perform at least one of:
when the probability of the calamity occurring in the location of the vehicle falls below a threshold, request additional information from the occupant regarding the calamity, wherein the additional information includes at least one of confirmation that the calamity is occurring and the location of the calamity;
provide alternate route options to choose from initially to the occupant before a trip has begun; and
provide alternate route options to the occupant after determination of the mood of the vehicle occupant.

9. A non-transitive computer-readable medium having instructions that, when executed by a processor, cause the processor to:
receive an input from an occupant of a vehicle describing a calamity when the vehicle is travelling on an initial route;
determine a mood of the occupant when the occupant provided the input; and
based on a probability of the calamity occurring in a location of the vehicle and the mood of the occupant, perform route planning for the vehicle for minimizing effects of the calamity on the vehicle.

10. The non-transitive computer-readable medium of claim 9, wherein the route plaining includes at least one of:
rerouting the vehicle to avoid an epicenter of the calamity;
rerouting the vehicle to utilize routes with a lesser probability calamity impacting the vehicle;
rerouting the vehicle to a home location;
providing options to the occupant to select a different route; and
providing information regarding the location of a shelter or another safe location.

11. A method comprising steps of:
receiving an input from an occupant of a vehicle describing a calamity when the vehicle is travelling on an initial route;
determining a mood of the occupant when the occupant provided the input; and
based on a probability of the calamity occurring in a location of the vehicle and the mood of the occupant, performing route planning for the vehicle for minimizing effects of the calamity on the vehicle.

12. The method of claim 11, wherein the input is an utterance from the occupant.

13. The method of claim 11, wherein the calamity is at least one of: an earthquake, forest fire, flood, tornado, hurricane, and tsunami.

14. The method of claim 11, further comprising the step of providing the probability to the occupant of the calamity occurring on the initial route before the vehicle proceeds along the initial route.

15. The method of claim 11, wherein the route plaining includes at least one of:
rerouting the vehicle to avoid an epicenter of the calamity;
rerouting the vehicle to utilize routes with a lesser probability of the calamity impacting the vehicle;
rerouting the vehicle to a home location;
providing options to the occupant to select a different route; and
providing information regarding the location of a shelter or another safe location.

16. The method of claim 11, further comprising the steps of:
receiving occupant data from an in-cabin sensor; and
based on the occupant data, determining the mood of the occupant, wherein the mood of the occupant includes at least one or more of: anger, sadness, fear, disgust, surprise, happy, and sociable.

17. The method of claim 16, further comprising the step of:
when the mood of the occupant is at least one of happy and sociable, requesting additional information from the occupant regarding the calamity.

18. The method of claim 17, wherein the additional information includes at least one of confirmation that the calamity is occurring and the location of the calamity.

19. The method of claim 11, further comprising at least one of:
when the probability of the calamity occurring in the location of the vehicle falls below a threshold, requesting additional information from the occupant regarding the calamity
providing alternate route options to choose from initially to the occupant before a trip has begun; and
providing alternate route options to the occupant after determination of the mood of the vehicle occupant.

20. The method of claim 19, wherein the additional information includes at least one of confirmation that the calamity is occurring and the location of the calamity.
